(19) United States
(12) Patent Application Publication
(10) Pub. No.: US 2003/0108323 A1
(43) Pub. Date: Jun. 12, 2003

(54) Optical fiber holder, optical fiber grating forming apparatus, optical fiber grating forming method, and optical fiber grating

(76) Inventor: Takashi Hashimoto, Tokyo (JP)

Correspondence Address: BURNS, DOANE, SWECKER & MATHIS, L.L.P., P.O. Box 1404, Alexandria, VA, 22313-1404, US

(21) Appl. No.: 10/273,150

(22) Filed: Oct. 18, 2002

(30) Foreign Application Priority Data
Dec. 10, 2001 (JP) 2001-376174

(51) Int. Cl. G02B 6/34

(52) U.S. Cl. 385/137; 385/37

(57) ABSTRACT

An optical fiber holder is provided with two cylindrical drums (6a and 6b) placed at a predetermined distance from each other and each having a groove (3) formed in a spiral fashion, both end portions of an optical fiber (1) being wound around the two cylindrical drums (6a and 6b), respectively, so that they are wound along the grooves (3) of the two cylindrical drums (6a and 6b), respectively. The two cylindrical drums (6a and 6b) are relatively moved in opposite directions so that they are away from each other to apply a desired tension to the optical fiber (1).

### BACKGROUND OF THE INVENTION

1. Field of the Invention

The present invention relates to an optical fiber holder for applying a tension to an optical fiber so as to hold the optical fiber. It further relates to an optical fiber grating forming apparatus for and an optical fiber grating forming method of providing an ultraviolet laser light pattern to a optical fiber being held so as to form an optical fiber grating in the optical fiber, and an optical fiber grating formed by using the optical fiber grating forming apparatus or the optical fiber grating forming method.

2. Description of Related Art

FIGS. 9A and 9B are diagrams showing the structure of a prior art optical fiber holder. In the side view of FIG. 9A and the cross-sectional view of FIG. 9B, reference numeral 101 denotes an optical fiber to which a tension (or tractive force) is applied so that the optical fiber is being held, and reference numeral 102 denotes a holder on which a V-shaped groove (or U-shaped groove) 103 is formed.

In the optical fiber holder of FIG. 9A, two positions of the optical fiber 101 are being held by the V-shaped grooves 103 of two holders 102. The two holders 102 are moved in opposite directions (i.e., the directions of arrows of FIG. 9A) so that they are away from each other, and when a desired tension is provided, the two holders 102 are stopped at rest. Methods of holding the optical fiber 101 in the V-shaped groove 103 of each of the two holders 102 includes a method of securing the optical fiber 101 to each holder 102 with an adhesive 104, as shown in FIG. 9C, and a method of pressing the optical fiber 101 against each holder 102 using a lid 105 having a projecting portion, as shown in FIG. 9D.

A problem with the prior art optical fiber holder as shown in FIGS. 9A and 9B is that since a ratio of parts of the optical fiber being held in the V-shaped grooves 103 of the two holders 102 to the entire optical fiber 101 is small, a large force is locally exerted on each of the parts of the optical fiber being held in the V-shaped grooves 103 of the two holders 102 when a desired tension is applied to the optical fiber, microbending and hence damage occurs in each of the parts of the optical fiber 101 being held in the V-shaped grooves 103 of the two holders 102. Therefore, before the tension applied to the optical fiber reaches a desired value, a crack may appear in each of the parts of the optical fiber 101 being held in the V-shaped grooves 103 of the two holders 102 or the optical fiber may be cut.

FIGS. 10A to 10D are diagrams showing the structure of an optical fiber holder which is the target of an experiment aimed at research purposes, which was done by the inventors of the present patent application before the present invention has been made. The same reference numerals as shown in FIGS. 9A to 9D denote the same components as those of the prior art optical fiber holder of FIGS. 9A and 9B or like components. In the side view of FIG. 10A, reference numerals 106a and 106b denote cylindrical drums (or pulleys or bobbins) around each of which an optical fiber 101 is wound.

In the optical fiber holder of FIG. 10A, the both ends of the optical fiber 101 are wound around the cylindrical drums 106a and 106, respectively. The cylindrical drums 106a and 106b are moved in opposite directions (i.e., the directions of arrows of FIG. 10A) so that they are away from each other, and when a desired tension is applied to the optical fiber 101, the two cylindrical drums 106a and 106b are stopped at rest. The both end portions of the optical fiber 101 are being held by the two cylindrical drums 106a and 106b, respectively, in such a manner that each of them overlaps and crosses itself when wound around a corresponding one of the two cylindrical drums for the second or later time, as shown in FIG. 10B.

Therefore, in the optical fiber holder of FIG. 1A, when the optical fiber 101 is wound around each of the two cylindrical drums 106a and 106b, a large stress is exerted on the corresponding overlapping and crossing part of the optical fiber 101. This stress causes damage to the optical fiber 101.

Each of the two cylindrical drums 106a and 106b needs to have a wide winding area A in which a corresponding end portion of the optical fiber 101 is wound because the corresponding end portion of the optical fiber 101 is so wound as to overlap and cross itself, as shown in FIG. 10B. Therefore, it is necessary to position the two cylindrical drums 106a and 106b so that both a position P where the optical fiber 101 is pulled out of the winding area A of a corresponding one of the two cylindrical drums 106a and 106b and a position P where the optical fiber 101 is wound into the winding area A of the other one of the two cylindrical drums 106a and 106b are maintained constant.

For example, in a case of forming an optical fiber grating by applying ultraviolet laser light to the optical fiber 101 in parallel with an optical axis Z, the ultraviolet laser light has to be applied to the optical fiber 101 in such a manner that the ultraviolet laser light is scanned in a direction perpendicular to the optical axis Z and the direction of the scanning agrees with the direction of the length of the optical fiber 101 (i.e., the direction of the optical axis of the optical fiber). However, when the optical fiber 101 is wound around each of the two cylindrical drums 106a and 106b, as shown in FIG. 10B, both the position P where the optical fiber 101 is pulled out of the winding area A of a corresponding one of the two cylindrical drums 106a and 106b and the position P where the optical fiber 101 is wound into the winding area A of the other one of the two cylindrical drums 106a and 106b are not maintained constant, as shown in FIGS. 10C and 10D.

Therefore, every time the optical fiber 101 is wound around the two cylindrical drums 106a and 106b, the rotational axes of the two cylindrical drums 106a and 106b need to be positioned so that they are in parallel with the optical axis Z and this results in an agreement between the optical axis of the optical fiber 101 and the direction of scanning the ultraviolet laser light. However, this positioning is extremely complex because the adjustment of the direction of one drum 106a (or 106b) causes a displacement of the direction of the other drum 106b (or 106a). In addition, since an attempt to move the two cylindrical drums 106a and 106b away from each other to apply a tension to the optical fiber 101 causes slight displacements of both the position P where the optical fiber 101 is pulled out of the winding area A of a corresponding one of the two cylindrical drums 106a and 106b and the position P where the optical fiber 101 is wound into the winding area A of the other one of the two cylindrical drums 106a and 106b, the positioning of the two cylindrical drums 106a and 106b with respect to the optical axis Z substantially becomes extremely difficult.

In FIG. 10C, when the optical fiber 101 is forwarded from the cylindrical drum 106a to the other cylindrical drum 106b so that an optical fiber grating is continuously formed in a not-yet-formed part of the optical fiber 101, the combination of the two cylindrical drums 106a and 106b changes into a state of FIG. 10D, for example. It is understood from the comparison between FIG. 10C and FIG. 10D that the hold position of the optical fiber 101 being held with respect to the optical axis Z has changed and the application condition of the ultraviolet laser light has also changed, and this results in reducing the degree of accuracy of forming the optical fiber grating. Therefore, the positioning of the two cylindrical drums 106a and 106b needs to be carried out in the optical fiber holder of FIG. 10A.

A prior art optical fiber holder constructed as mentioned above is that since a large force is locally exerted on an optical fiber being held by the optical fiber holder, the optical fiber holder causes damage to the optical fiber.

A problem with an optical fiber holder as shown in FIG. 10A is that the positioning of two cylindrical drums is needed to hold the position of an optical fiber being held by the optical fiber holder, which can change every time the optical fiber is wound back or forward by the two cylindrical drums, and therefore a complex mechanism for positioning the two cylindrical drums is needed.

### SUMMARY OF THE INVENTION

The present invention is proposed to solve the above-mentioned problems, and it is therefore an object of the present invention to provide an optical fiber holder capable of holding an optical fiber without causing damage to the optical fiber, keeping the optical axis of the optical fiber constant every time the optical fiber is replaced by a new one, and keeping the hold position of the optical fiber being held constant every time the optical fiber is wound back or forward by a certain length thereof without positioning the two cylindrical drums with respect to a direction of their axes.

It is another object of the present invention to provide an optical fiber grating forming apparatus and an optical fiber grating forming method suitable for continuous forming of optical fiber gratings.

It is a further object of the present invention to provide an optical fiber grating formed by using the above-mentioned optical fiber grating forming apparatus or the above-mentioned optical fiber grating forming method.

In accordance with an aspect of the present invention, there is provided an optical fiber holder including: a first cylindrical winding member having a groove along which an end portion of an optical fiber is wound thereon; a second cylindrical winding member having a groove along which another end portion of the optical fiber is wound thereon and placed at a predetermined distance from the first cylindrical winding member; and a moving mechanism for moving at least one of the first and second cylindrical winding members so as to apply a tension to the optical fiber.

In accordance with another aspect of the present invention, there is provided an optical fiber grating forming apparatus including: at least one optical fiber holder according to the first aspect of the present invention; a laser light source for emitting ultraviolet laser light; a scanning mechanism for scanning the ultraviolet laser light from the laser light source in a direction of a length of at least an optical fiber, which is being held by the optical fiber holder substantially in parallel with one or more other optical fibers; and a phase mask for projecting the ultraviolet laser light from the scanning mechanism onto the optical fiber as an interference pattern.

In accordance with an aspect of the present invention, there is provided an optical fiber grating forming method having the steps of: removing a part of a sheath of an optical fiber cut to an appropriate length so that an optical fiber grating can be formed in the optical fiber; applying a tension to the optical fiber by using one optical fiber holder according to the first aspect of the present invention; scanning ultraviolet laser light from a laser light source in a direction of a length of the optical fiber; and projecting the scanned ultraviolet laser light, by way of a phase mask and the removed part of the sheath of the optical fiber, onto the optical fiber as an interference pattern.

As a result, the present invention offers an advantage of being able to prevent a load from being locally exerted on an optical fiber to be processed, thereby securely holding the optical fiber while preventing microbending from occurring in the optical fiber. The present invention further offers another advantage of being able to hold both a position where an end portion of the optical fiber is pulled out of the optical fiber holder and a position where another end portion of the optical fiber is wound into the optical fiber holder.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the structure of a main part of an optical fiber holder according to embodiment 1 of the present invention;

FIG. 2 is a diagram showing the structure of each of two cylindrical drums for use in the optical fiber holder according to embodiment 1 of the present invention;

FIGS. 3A and 3B are diagrams for explaining the operation of the optical fiber holder according to embodiment 1 of the present invention;

FIGS. 4A to 4C are diagrams showing variations of a cross-sectional shape of a V-shaped groove formed in each of the two cylindrical drums of the optical fiber holder according to embodiment 1 of the present invention;

FIGS. 5A and 5B are diagrams for explaining relative positions of the two cylindrical drums of the optical fiber holder according to embodiment 1 of the present invention;

FIG. 5C is a diagram showing a sleeve with a crack for use in the optical fiber holder according to embodiment 1 of the present invention;

FIGS. 6A and 6B are diagrams showing the structure of the optical fiber holder according to embodiment 1 of the present invention;

FIG. 7 is a diagram showing the structure of an optical fiber grating forming apparatus according to embodiment 2 of the present invention;

FIG. 8 is a flow chart for explaining the operation of the optical fiber grating forming apparatus according to embodiment 2 of the present invention;

FIGS. 9A to 9D are diagrams showing the structure of a, prior art optical fiber holder; and

FIGS. 10A to 10D are diagrams showing the structure of an optical fiber holder which is the target of an experiment aimed at research purposes, which was done by the inventors of the present patent application before the present invention has been made.

### DETAILED DESCRIPTION OF THE PREFERRED EMBODIMENTS

The invention will now be described with reference to the accompanying drawings.

Embodiment 1.

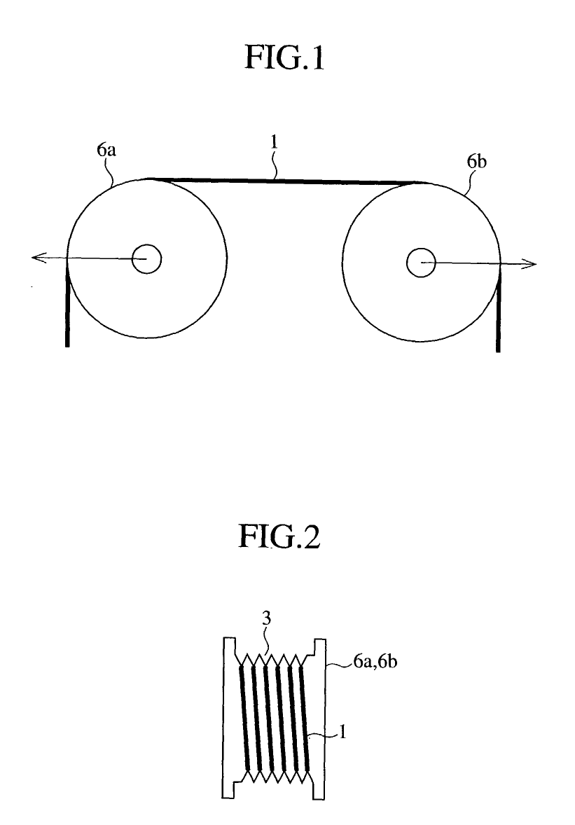

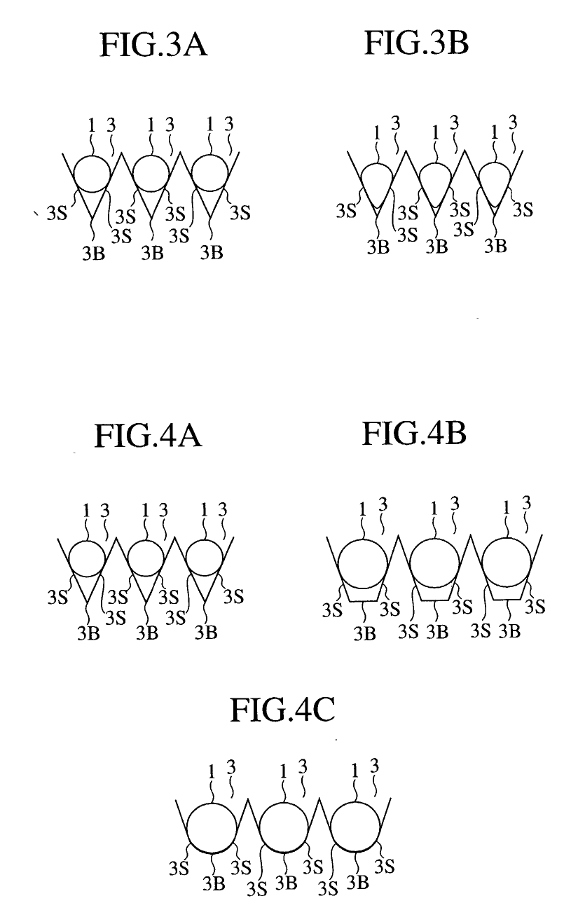

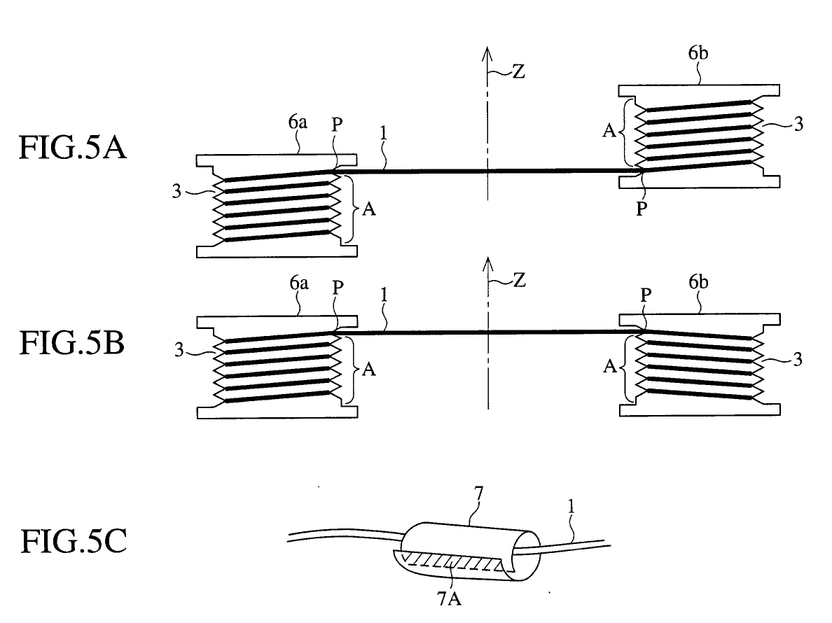

FIG. 1 is a diagram showing the structure of an optical fiber holder according to embodiment 1 of the present invention, and FIG. 2 is a diagram showing the structure of each of two cylindrical drums for use in the optical fiber holder according to embodiment 1 of the present invention. FIGS. 3A and 3B are diagrams for explaining the operation of the optical fiber holder according to embodiment 1 of the present invention, FIGS. 4A to 4C are diagrams showing variations of a cross-sectional shape of a V-shaped groove formed in each of the two cylindrical drums of the optical fiber holder according to embodiment 1 of the present invention, FIGS. 5A and 5B are diagrams for explaining relative positions of the two cylindrical drums of the optical fiber holder according to embodiment 1 of the present invention, and FIG. 5C is a diagram showing a sleeve with a crack for use in the optical fiber holder according to embodiment 1 of the present invention.

In the side view of FIG. 1 and the front elevation of FIG. 2, reference numeral 1 denotes an optical fiber to which a tension is applied so that it is being held, and reference numerals 6a and 6b denote cylindrical drums (pulleys or bobbins, i.e., first and second cylindrical winding members) each having a lateral face in which a groove 3, along which the optical fiber 1 is wound, is formed in a spiral fashion. The two cylindrical drums 6a and 6b are arranged at a predetermined distance from each other and are so constructed as to apply a desired tension to the optical fiber 1.

Next, a description will be made as to the operation of the optical fiber holder according to embodiment 1 of the present invention. The optical fiber holder according to embodiment 1 of the present invention is characterized in that it uses the two cylindrical drums 6a and 6b of FIG. 2, each of which has a spiral groove 3 formed in a winding area A thereof. As shown in FIG. 1, the optical fiber 1 having a sheath is wound two or more turns along the groove 3 of each of the two cylindrical drums 6a and 6b. By relatively moving the two cylindrical drums 6a and 6b in opposite directions (i.e., the directions of the arrows of FIG. 1) so that they are away from each other by using a moving mechanism not shown in the figure so as to further pull the optical fiber 1, the optical fiber holder applies a tension to the optical fiber 1. When the tension then reaches a desired value, the optical fiber holder stops the movements of the two cylindrical drums 6a and 6b and holds the optical fiber 1. The rotations of the two cylindrical drums 6a and 6b are stopped while the two cylindrical drums 6a and 6b are relatively moved in opposite directions.

At that time, each end portion of the optical fiber 1 being held along the groove 3 as shown in an enlarged cross-sectional view of FIG. 3A is attracted to the bottom 3B of the groove 3 by the tension applied to the optical fiber 1, so that the sheath of each end portion of the optical fiber 1 becomes deformed according to the lateral surface 3S and fits into the groove 3, and then comes in good contact with the lateral surface 3S of the groove 3. The status of each end portion of the optical fiber 1 at this time is shown in an enlarged cross-sectional view of FIG. 3B, and a friction force with respect to the tension increases because the contact area in which the optical fiber 1 is brought into contact with the lateral surface 3S of the groove 3 increases due to the deformation of the sheath. As a result, a desired tension is applied to the optical fiber 1 so that the optical fiber 1 is being held while the optical fiber 1 does not slide.

The inventors of the present patent application have made sure that the optical fiber 1 is being surely held so that it does not slide on the condition that the diameter of the optical fiber 1 is 125 micrometers, the length of the optical fiber 1 including the sheath is 250 micrometers, the material of the optical fiber 1 is a PVC (polyvinyl chloride) resin, a UV curing resin, or the like, the tension applied to the optical fiber 1 is 1 kg weight (in this case, the optical fiber 1 is wound about three to five turns around each of the two cylindrical drums 6a and 6b having a diameter of 60 mmΦ). The inventors of the present patent application have also made sure that when the optical fiber 1 is wound two turns around each of the two cylindrical drums 6a and 6b, the optical fiber 1 can easily slide, whereas the optical fiber 1 can be surely held by forming a spiral groove 3 having three or more turns in the lateral surface of each of the two cylindrical drums 6a and 6b.

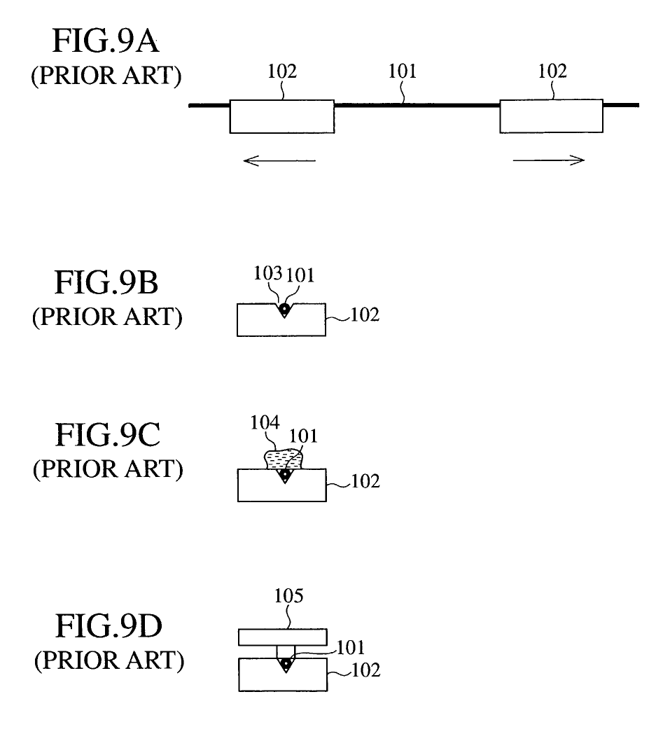

Thus, the optical fiber holder of this embodiment 1 delocalizes the application of a stress caused by the tension and hence distributes the stress over the entire optical fiber 1 having a sheath partially in contact with the lateral surface 3S of the groove 3 of each of the two cylindrical drums 6a and 6b, unlike the prior art optical fiber holder as shown in FIGS. 9A and 9B. Therefore, the present embodiment offers an advantage of being able to prevent microbending from occurring in the optical fiber, thereby holding the optical fiber 1 without causing damage to the optical fiber 1.

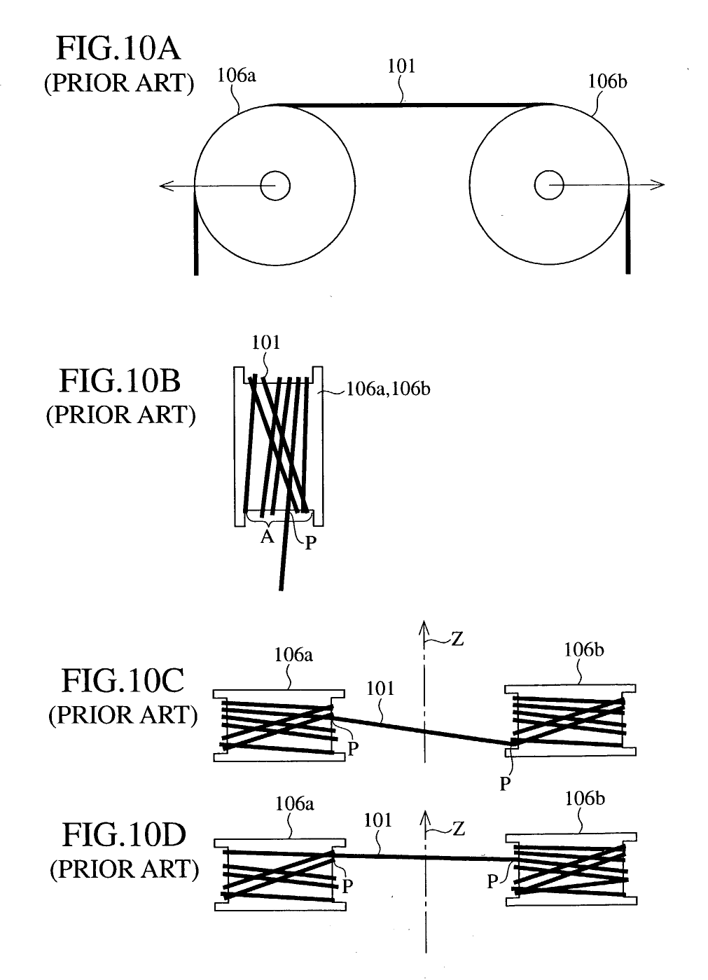

Furthermore, in each of the two cylindrical drums 6a and 6b, since the optical fiber 1 is placed in the groove 3, the optical fiber holder need not cause the optical fiber 1 to overlap and cross itself in each of the two cylindrical drums 6a and 6b and never causes damage to the optical fiber 1, unlike the prior art optical fiber holder of FIGS. 10A and 10B. In other words, since the optical fiber holder according to embodiment 1 of the present invention are holding the optical fiber 1 by using a friction force generated in the groove 3 of each of the two cylindrical drums 6a and 6b by winding the optical fiber 1 around each of the two cylindrical drums 6a and 6b, the optical fiber holder distributes the force over the entire length of the optical fiber 1 which is wound around each of the two cylindrical drums 6a and 6b (as if in a tug-of-war game each member shares a force applied to a rope) without locally exerting the force on the optical fiber 1, thereby preventing damage to the optical fiber 1.

The groove 3 of each of the two cylindrical drums 6a and 6b can have a V-shaped cross section as shown in FIG. 4A. As an alternative, the groove 3 of each of the two cylindrical drums 6a and 6b can have a cross section, as shown in FIG. 4B, having two sloped sides 3S and a bottom 3B of planar shape, or can have a cross section, as shown in FIG. 4C, having two sloped sides 3S and a bottom 3B of curved shape. It is noted that in either case the groove 3 is formed so as to have a cross-sectional width which becomes narrower with reaching the rotational axis of each of the two cylindrical drums 6a and 6b (i.e., have a cross-sectional shape like the inversion of a katakana character of [symbol] ). When the groove 3 has a bottom 3B shaped as shown in FIG. 4B or 4C, the contact area in which the optical fiber 1 transformed by the addition of the tension is brought into contact with the groove 3 further increases because of the bottom 3B and therefore the optical fiber 1 further resists sliding.

Furthermore, as shown in FIGS. 5A and 5B, the two cylindrical drums 6a or 6b can have either of the following configurations A and B.

Configuration A: the groove 3 of the first cylindrical drum 6a is so formed as to rotate in the same direction as that in which the groove 3 of the second cylindrical drum 6b rotates when viewed in a direction of the rotational axes of the first and second cylindrical drums 6a and 6b (i.e., +Z direction of FIG. 5A). In other words, the grooves 3 of the first and second cylindrical drums 6a and 6b are right-hand or left-hand spiral grooves (right-hand grooves in the case of FIG. 5A). The first and second cylindrical drums 6a and 6b are arranged so that an offset between them with respect to the direction of the rotational axes of the first and second cylindrical drums 6a and 6b is substantially equal to the width of the winding area A of each of the first and second cylindrical drums 6a and 6b, on which the optical fiber 1 is wound (see FIG. 5A).

Configuration B: the groove 3 of the first cylindrical drum 6a is so formed as to rotate in a direction different from that in which the groove 3 of the second cylindrical drum 6b rotates when viewed in the direction of the rotational axes of the first and second cylindrical drums 6a and 6b. In other words, the grooves 3 of the first and second cylindrical drums 6a and 6b are a right-hand spiral groove and a left-hand spiral groove. The first and second cylindrical drums 6a and 6b are arranged so that an offset between them with respect to the direction of the rotational axes of the first and second cylindrical drums 6a and 6b is substantially set to zero (see FIG. 5B).

As can be seen from FIGS. 5A and 5B, in this optical fiber holder, since the optical fiber 1 is arranged along the groove 3 in each of the two cylindrical drums 6a and 6b, both a position P where the optical fiber 1 is pulled out of the winding area A of one of the two cylindrical drums 6a and 6b and a position P where the optical fiber 1 is wound into the winding area A of the other one of the two cylindrical drums 6a and 6b can be maintained constant at all times. Therefore, the hold position of the optical fiber 1 being held between the two cylindrical drums 6a and 6b can be maintained constant at all times with respect to the optical axis Z, as shown in FIGS. 5A and 5B, of laser light to be applied to the optical fiber (the optical axis Z only has to be perpendicular to the direction of the length of the optical fiber 1 being held between the two cylindrical drums 6a and 6b, and therefore, can alternatively be a direction perpendicular to the figure).

After completing processing such as application of ultraviolet laser light to the optical fiber 1 having a predetermined length and being held between the two cylindrical drums 6a and 6b, the optical fiber 1 can be replaced by a new one as follows. First of all, the two cylindrical drums 6a and 6b are made to approach each other and the application of the tension to the optical fiber 1 is released. Next, the optical fiber 1 wound around the groove 3 of each of the two cylindrical drums 6a and 6b is loosened by a user's hand, and the optical fiber 1 is detached from the two cylindrical drums 6a and 6b. After a new optical fiber 1 is then wound around the groove 3 of each of the two cylindrical drums 6a and 6b, the two cylindrical drums 6a and 6b are relatively moved away from each other so that a desired tension is applied to the new optical fiber 1. At this time, when viewed in the direction of the optical axis Z of laser light to be applied to the optical fiber, the positional relationship between the optical fiber 1 and the two cylindrical drums 6a and 6b is the same as that before the replacement, and therefore, the hold position of the optical fiber 1 being held between the two cylindrical drums 6a and 6b is maintained constant with respect to the optical axis Z. Thus, when the optical fiber 1 is detached and is replaced by a new one, the optical fiber holder need not position the rotational axes of the two cylindrical drums 6a and 6b with respect to the optical axis Z, unlike prior art optical fiber holders.

Users are allowed to bring the two cylindrical drum 6a and 6b close to each other so as to release the application of the tension to the optical fiber 1, to wind the optical fiber 1 back or forward along the groove 3 of each of the two cylindrical drums 6a and 6b by sliding the optical fiber 1 using their hands, and to move the two cylindrical drums 6a and 6b away from each other so as to apply a tension to the optical fiber 1 again when a desired length of the optical fiber is forwarded. Thus users can forward the optical fiber 1 manually. Therefore the present embodiment offers an advantage of being able to allow users to forward the optical fiber 1 manually without having to position the two cylindrical drums 6a and 6b and without detaching and replacing the optical fiber 1 with a new one, so that the optical fiber 1 can be processed continuously.

Particularly, when the sheath of the optical fiber 1 is partially removed and an optical fiber grating is formed in the optical fiber 1, since the removed part of the sheath of the optical fiber 1 is more likely to suffer damage from the two cylindrical drums 6a and 6b, the optical fiber 1 can be temporarily detached from the two cylindrical drums 6a and 6b and an end portion of the optical fiber 1 wound around the second cylindrical drum 6b is wound around the first cylindrical drum 6a so that the removed part (which corresponds to a work area to be processed of the optical fiber 1) of the sheath of the optical fiber 1 is not wound around each of the two cylindrical drums 6a and 6b, for example, and another end potion of the optical fiber 1 is wound around the second cylindrical drum 6b so that the other end portion of the optical fiber is at a certain distance from the end portion of the optical fiber wound around the first cylindrical drum 6a and the work area to be processed of the optical fiber is not wound around each of the two cylindrical drums 6a and 6b.

As an alternative, after protecting the removed part of the sheath from damage by using a sleeve 7 having a crack, as shown in FIG. 5C, for example, the optical fiber 1 can be forwarded. The sleeve 7 formed like a straw, in which a crack is formed, has an overlapping portion 7A so as to enclose the optical fiber 1 one or more deep.

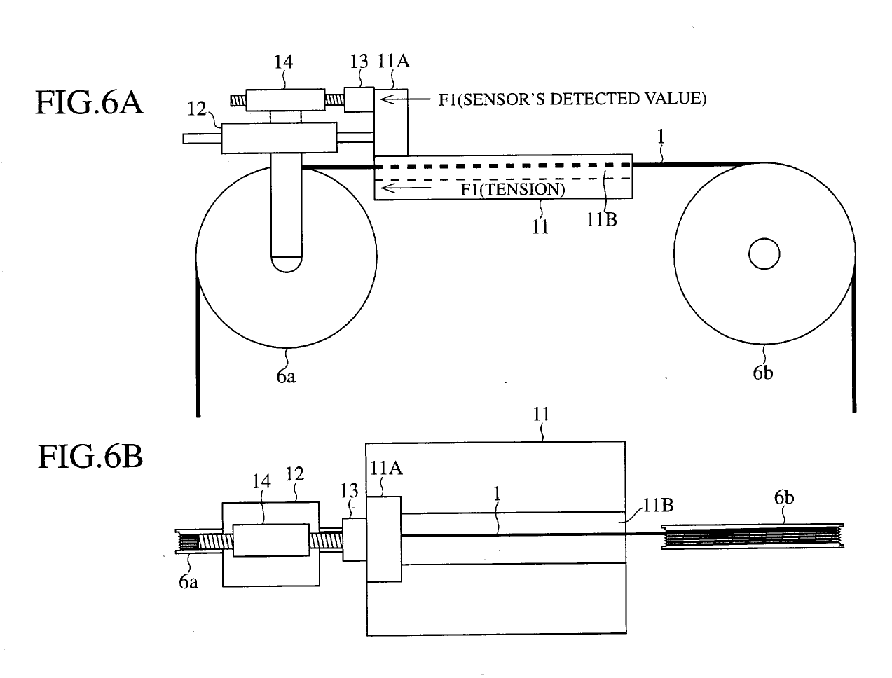

In addition, the optical fiber holder (particularly, a moving mechanism) of FIG. 1 can be so constructed as to determine a tension applied to the optical fiber 1. FIGS. 6A and 6B are diagrams showing the structure of the optical fiber holder according to embodiment 1 of the present invention. The same reference numerals as shown in FIGS. 1 and 2 denote the same components or like components. In FIGS. 6A and 6B, reference numeral 11 denotes a base in which the optical fiber 1 is arranged along a groove 11B, reference numeral 12 denotes a linear stage, reference numeral 13 denotes a force sensor, such as a piezoelectric element, and reference numeral 14 denotes a micrometer (adjustment means).

In the optical fiber holder of FIGS. 6A and 6B, the two cylindrical drums 6a and 6b are arranged at a distance from each other. Each of the two cylindrical drums 6a and 6b has a rotation locking mechanism of locking the rotation of each of the two cylindrical drums 6a and 6b around its rotational axis. After the optical fiber 1 has been positioned, in each of the two cylindrical drums 6a and 6b the locking mechanism locks the rotation of each of the two cylindrical drums 6a and 6b. The first cylindrical drum 6a shown in the left-hand side of FIG. 6A is coupled to the linear stage 12 so that it can move in a horizontal direction. On the other hand, the rotational axis of the second cylindrical drum 6b shown in the right-hand side of FIG. 6A is secured to the base 11 (not shown in the figure).

A guide of the linear stage 12 is coupled to a wall 11A of the base 11, and a micrometer 14 is secured onto the linear stage 12. The micrometer 14 is so constructed as to press the wall 11A of the base 11 by way of the force sensor 13 when the micrometer 14 is turned clockwise. As a result, a tension is applied to the optical fiber 1. The tension applied to the optical fiber 1 is transmitted to the force sensor 13 placed between the micrometer 14 and the wall 11A as a distortion, and can be monitored by converting a voltage signal generated by the force sensor 13 according to this distortion into an analog value. The force sensor 13 is not limited to the one of such a piezoelectric element type, and only has to be able to monitor the tension applied to the optical fiber 1.

Since the sheath of the optical fiber 1 is partially removed according to the work area of the optical fiber 1 where an optical fiber grating is to be formed, the work area of the optical fiber 1 suffers damage when brought into contact with the groove 3 of any one of the two cylindrical drums 6a and 6b. Therefore, after the optical fiber 1 is wound around each of the two cylindrical drums 6a and 6b manually, the two cylindrical drums 6a and 6b are rotated and are then locked when the work area of the optical fiber 1 matches an area to be exposed to ultraviolet laser light.

An actuator (control means) including, for example, a motor and a driver can be disposed instead of the micrometer 14 of FIGS. 6A and 6B, and a controller (control means) for automatically feed-back-controlling the actuator based on the tension detected by the force sensor 13 can be disposed. The actuator and controller are not shown in the figure. In this variant, the optical fiber holder can hold the optical fiber 1 with a higher degree of accuracy.

As mentioned above, in accordance with this embodiment 1, the optical fiber holder is provided with two cylindrical drums 6a and 6b placed at a predetermined distance from each other, each of the two cylindrical drums 6a and 6b having a spiral groove 3 formed in a lateral surface thereof, and both end portions of an optical fiber 1 being wound around the two cylindrical drums 6a and 6b so that they are wound along the grooves 3 of the two cylindrical drums 6a and 6b, respectively, and is further provided with a moving mechanism for relatively moving the two cylindrical drums 6a and 6b in opposite directions so that they are away from each other to apply a desired tension to the optical fiber 1. As a result, the optical fiber holder can prevent a load from being locally exerted on the optical fiber 1, thereby preventing the optical fiber 1 from finally being cut due to microbending. Furthermore, the optical fiber holder can apply a desired tension to the optical fiber 1 to hold and secure it while holding the optical fiber 1 so that it is running in a direction perpendicular to the optical axis Z of ultraviolet laser light to be applied to the optical fiber.

In addition, when processing the optical fiber 1 by continuously applying a tension to the optical fiber 1, the optical fiber holder can place a work area in a constant position without positioning the two cylindrical drums 6a and 6b with respect to the direction of the optical axis Z of ultraviolet laser light to be applied to the optical fiber 1 or without detaching and replacing the optical fiber 1 with a new one.

Furthermore, in according with this embodiment 1, users can be allowed to bring the two cylindrical drums 6a and 6b close to each other so that the application of the tension to the optical fiber 1 is released, to manually slide the optical fiber 1 along the groove 3 of each of the two cylindrical drums 6a and 6b so as to wind the optical fiber 1 back or forward, and to move the two cylindrical drums 6a and 6b away from each other so as to apply a tension to the optical fiber 1 again when a desired length of the optical fiber 1 is forwarded. Therefore the present embodiment offers an advantage of being able to allow users to forward the optical fiber 1 manually without having to position the two cylindrical drums 6a and 6b with respect to the optical axis Z of ultraviolet laser light to be applied to the optical fiber 1 or without detaching and replacing the optical fiber 1 with a new one, so that the optical fiber 1 can be processed continuously.

In addition, in accordance with this embodiment 1, in each of the two cylindrical drums 6a and 6b, the groove 3 is formed in a spiral fashion in a lateral surface of each of the two cylindrical drums 6a and 6b and has a cross-sectional width which becomes narrower with reaching the rotational axis of each of the two cylindrical drums 6a and 6b. Therefore the present embodiment offers an advantage of being able to increase the contact area in which the optical fiber 1 is brought into contact with the groove 3 of each of the two cylindrical drums, thereby preventing the optical fiber 1 from sliding.

In accordance with this embodiment 1, in each of the two cylindrical drums 6a and 6b, the groove 3 can have a bottom of planar or curved shape. Therefore the present embodiment offers an advantage of being able to further increase the contact area in which the optical fiber 1 is brought into contact with the groove 3 of each of the two cylindrical drums, thereby preventing the optical fiber 1 from sliding more effectively.

In addition, in accordance with this embodiment 1, in both of the two cylindrical drums 6a and 6b, the spiral groove 3 has three or more turns. Therefore the present embodiment offers an advantage of being able to surely hold the optical fiber 1.

Furthermore, in accordance with this embodiment 1, the grooves 3 of the two cylindrical drums 6a and 6b are so formed as to rotate in opposite directions when viewed in the direction of the rotational axes of the two cylindrical drums 6a and 6b, that is, the grooves 3 of the two cylindrical drums 6a and 6b are a right-hand spiral groove and a left-hand spiral groove, and the two cylindrical drums 6a and 6b are arranged so that an offset between them with respect to the direction of the rotational axes of the two cylindrical drums 6a and 6b is substantially set to zero. Therefore the present embodiment offers an advantage of being able to hold both a position P where the optical fiber 1 is pulled out of the winding area A of one of the two cylindrical drums 6a and 6b and a position P where the optical fiber 1 is wound into the winding area A of the other one of the two cylindrical drums 6a and 6b at all times.

In addition, in accordance with this embodiment 1, the grooves 3 of the two cylindrical drums 6a and 6b are so formed as to rotate in the same direction when viewed in the direction of the rotational axes of the two cylindrical drums 6a and 6b, that is, the grooves 3 of the two cylindrical drums 6a and 6b are right-hand (or left-hand) spiral grooves, and the two cylindrical drums 6a and 6b are arranged so that an offset between them with respect to the direction of the rotational axes of the two cylindrical drums 6a and 6b is substantially equal to the width of the winding area A. Therefore the present embodiment offers an advantage of being able to hold both a position P where the optical fiber 1 is pulled out of the winding area A of one of the two cylindrical drums 6a and 6b and a position P where the optical fiber 1 is wound into the winding area A of the other one of the two cylindrical drums 6a and 6b at all times.

Furthermore, in accordance with this embodiment 1, the optical fiber holder is further provided with a sleeve 7 having a crack and formed like a straw, for enclosing the optical fiber 1. Therefore the present embodiment offers an advantage of being able to protect a part of the optical fiber 1 whose sheath is removed from damage caused by the winding of the two cylindrical drums 6a and 6b.

In addition, in accordance with this embodiment 1, the optical fiber holder is further provided with a base 11 secured to the second cylindrical drum 6b, a linear stage 12 for holding the first cylindrical drum 6a and for moving the first cylindrical drum 6a in the direction of the length of the optical fiber 1, and a micrometer 14 for adjusting the distance between the base 11 and the linear stage 12 by moving the linear stage 12. Therefore the present embodiment offers an advantage of being able to accurately determine the tension applied to the optical fiber 1.

Furthermore, in accordance with this embodiment 1, each of the two cylindrical drums 6a and 6b is being held rotatably so that it can rotate around its rotational axis and is provided with a rotation lock mechanism of locking the rotation of each of the two cylindrical drums 6a and 6b around the rotational axis. Therefore the present embodiment offers an advantage of being able to easily move the two cylindrical drums 6a and 6b when applying a tension to the optical fiber 1.

In addition, in accordance with this embodiment 1, the optical fiber holder is further provided with a force sensor 13 placed between the base 11 and the micrometer 14, for detecting a force applied thereto from the micrometer 14 in a direction in which the linear stage 12 can be moved. Therefore the present embodiment offers an advantage of being able to accurately determine the tension applied to the optical fiber 1.

Furthermore, in accordance with this embodiment 1, the optical fiber holder is further provided with an actuator for applying a force to the force sensor 13, and a controller for controlling the force applied to the force sensor 13 by the actuator by referring to the force detected by the force sensor 13. Therefore the present embodiment offers an advantage of being able to hold the optical fiber 1 with a higher degree of accuracy.

Embodiment 2.

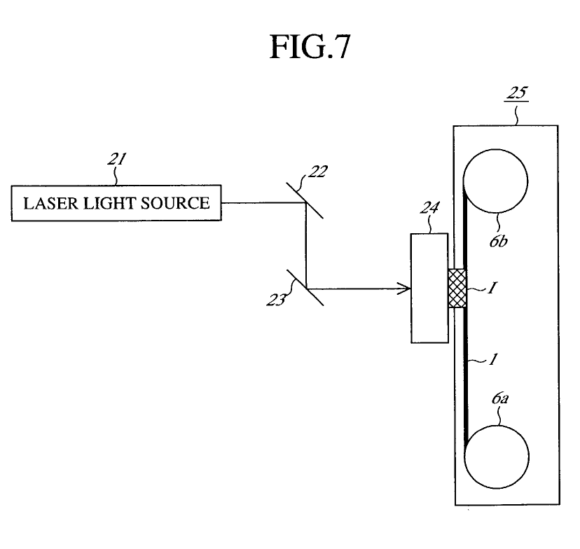

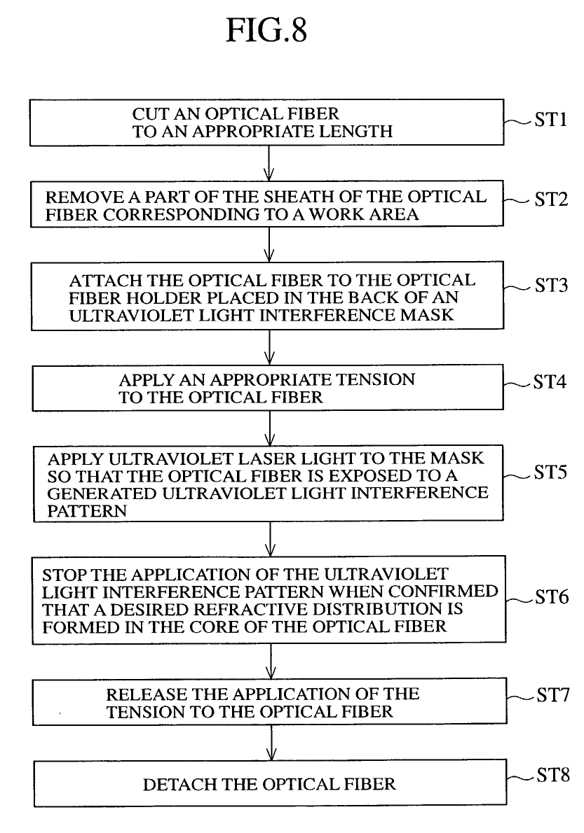

FIG. 7 is a diagram showing the structure of an optical fiber grating forming apparatus according to embodiment 2 of the present invention. The same reference numerals as shown in FIGS. 1 and 2 denote the same components as those of the optical fiber holder of embodiment 1 or like components. FIG. 8 is a flow chart for explaining the operation of the optical fiber grating forming apparatus according to embodiment 2 of the present invention.

In FIG. 7, reference numeral 21 denotes a laser light source for emitting ultraviolet laser light, reference numeral 22 denotes a fixed reflector for reflecting the ultraviolet laser light from the laser light source 21, reference numeral 23 denotes a moving reflector (scanning means) for reflecting the ultraviolet laser light from the fixed reflector 22 so as to scan the ultraviolet laser light in the direction of the length of an optical fiber 1, reference numeral 24 denotes a phase mask for converting the ultraviolet laser light from the moving reflector 23 into an interference pattern 1 and for projecting the interference pattern 1 onto the optical fiber 1, and reference numeral 25 denotes an optical fiber holder according to embodiment 1 of the present invention as shown in FIG. 6. In the optical fiber grating forming apparatus of FIG. 7, the optical fiber 1 placed at the back of the phase mask 24 is being held by the optical fiber holder 25.

Next, a description will be made as to the operation of the optical fiber grating forming apparatus according to embodiment 2 of the present invention. As shown in FIG. 8, the optical fiber 1 having a Ge-doped core is cut to an appropriate length (in step STI), and a part of the sheath of the optical fiber 1 corresponding to a work area is removed (in step ST2). As in the case of embodiment 1, the optical fiber 1 is then attached to the optical fiber holder 25 placed at the back of the phase mask 24 (in step ST3), so that the optical fiber holder 25 can apply an appropriate tension to the optical fiber 1 (in step ST4).

After a desired tension is applied to the optical fiber 1, ultraviolet laser light from the laser light source 21 is applied to the phase mask 24 by way of the fixed reflector 22 and the moving reflector 23, and an interference pattern 1 of the ultraviolet laser light is then applied to a lateral surface of the optical fiber 1 (in step ST5). As a result, a photochemical change is caused in the core of the optical fiber 1 according to an illumination distribution of the interference pattern 1, so that a periodic refractive distribution is produced in the core of the optical fiber 1 and therefore a grating is formed.

When confirmed that a desired refractive distribution is formed in the core of the optical fiber 1, the application of the interference pattern 1 is stopped (in step ST6). This confirmation is carried out by applying laser light to the optical fiber 1 and by observing the characteristics (reflected wavelength range, penetration loss, reflection loss, and so on) of the laser light reflected by the optical fiber grating formed in the optical fiber 1. After completing the application of the interference pattern 1, the application of the tension is released (in step ST7) and it is confirmed whether the reflected wavelength range (or the center of the wavelength range) matches a designed one. The optical fiber 1 is then detached from the optical fiber holder 25 (in step ST8).

Thus, the optical fiber holder 25 can be used in the case of forming a grating in the core of the optical fiber 1. The optical fiber 1 to be processed needs to be placed in an accurate position onto which the interference pattern 1 is accurately projected without being displaced from its desired position while being processed. To this end, by using the optical fiber holder 25 of embodiment 1, a tension is applied to the optical fiber 1 so that the optical fiber 1 is not loosened.

It is necessary to adjust and set the wavelength of laser light which can be reflected by the optical fiber grating with a high degree of accuracy. The wavelength of the reflected laser light is given by the product of the basic refractive index of the core and the grating spacing, and can be adjusted by changing either of these two parameters. The basic refractive index of the core can be varied by heating the core, and the grating spacing can be varied by changing the length of the optical fiber 1.

In this embodiment 2, it is assumed that the latter method of adjusting the wavelength of the reflected light by changing the length of the optical fiber 1 is used, and the length of the optical fiber 1 can be varied by pulling the optical fiber 1. An interference pattern 1 is applied to the optical fiber while an arbitrary tension is applied to the optical fiber 1 so that an optical fiber grating is formed in the core. After that, when the application of the tension is released, the stability of the optical fiber 1 provides a grating spacing for the optical fiber grating formed. This grating spacing is set so that a desired reflection wavelength is provided.

In a variant of embodiment 2, two or more optical fiber holders 25 are provided, two or more corresponding optical fibers 1 are attached to the two or more optical fiber holders 25, respectively, so that they are running in substantially parallel with one another, and the interference pattern 1 is simultaneously applied to the two or more optical fibers 1. As a result, the efficiency of production of optical fiber gratings can be improved. Of course, the efficiency of production of optical fiber gratings can be further improved by combining the continuous processing by forwarding the optical fiber 1, as described in embodiment 1, and the simultaneous projection of the interference pattern 1 onto the two or more optical fibers 1.

As mentioned above, in accordance with this embodiment 2, the optical fiber grating forming apparatus is provided with at least an optical fiber holder 25 for applying a tension to an optical fiber 1 cut to an appropriate length, a part of the sheath of the optical fiber 1 corresponding to a word area being removed, a laser light source 21 for emitting ultraviolet laser light, a combination of a fixed reflector 22 and a moving reflector 23 for scanning the ultraviolet laser light from the laser light source 21 in the direction of the length of at least the optical fiber 1, which is being held by the optical fiber holder 25 substantially in parallel with one or more other optical fibers, and a phase mask 24 for projecting the ultraviolet laser light from the moving reflector 23 onto at least the optical fiber 1 as an interference pattern 1. Therefore the present embodiment offers an advantage of being able to place the optical fiber 1 to be processed in an accurate position onto which the interference pattern 1 is accurately projected and to hold the optical fiber 1 so that it is not displaced from its desired position while being processed, thereby continuously forming optical fiber gratings and improving the efficiency of production of optical fiber gratings.

In addition, in accordance with this embodiment 2, two or more optical fiber holders 25 can be provided, two or more corresponding optical fibers 1 can be attached to the two or more optical fiber holders 25, respectively, so that they are running in substantially parallel with one another, and an interference pattern 1 is simultaneously applied to the two or more optical fibers 1. Therefore the present embodiment offers an advantage of being able to improve the efficiency of production of optical fiber gratings.

Furthermore, in accordance with this embodiment 2, the optical fiber grating forming method has the steps of removing a part of the sheath of an optical fiber 1 cut to an appropriate length, the part of the sheath corresponding to a work area of the optical fiber 1, applying a tension to the optical fiber 1 being held by an optical fiber holder 25, scanning ultraviolet laser light from a laser light source 21 in the direction of the length of the optical fiber 1, and projecting the scanned ultraviolet laser light, by way of a phase mask 24, onto the work area of the optical fiber 1 as an interference pattern 1. Therefore the present embodiment offers an advantage of being able to place the optical fiber 1 to be processed in an accurate position onto which the interference pattern 1 is accurately projected and to hold the optical fiber 1 so that it is not displaced from its desired position while being processed, thereby improving the efficiency of production of optical fiber gratings and continuously forming optical fiber gratings.

In addition, in accordance with this embodiment 2, a grating can be formed in the optical fiber 1 by using the above-mentioned optical fiber grating forming apparatus (or the above-mentioned optical fiber grating processing method). Therefore the present embodiment offers an advantage of being able to provide an optical fiber grating whose grating spacing is accurately provided.

Many widely different embodiments of the present invention may be constructed without departing from the spirit and scope of the present invention. It should be understood that the present invention is not limited to the specific embodiments described in the specification, except as defined in the appended claims.

What is claimed is:

1. An optical fiber holder comprising:
a first cylindrical winding member having a groove along which an end portion of an optical fiber is wound thereon;
a second cylindrical winding member having a groove along which another end portion of said optical fiber is wound thereon and placed at a predetermined distance from said first cylindrical winding member; and
a moving means for moving at least one of said first and second cylindrical winding members so as to apply a tension to said optical fiber.

2. The optical fiber holder according to claim 1, wherein in each of said first and second cylindrical winding members, the groove is formed in a spiral fashion in a lateral surface of each of said first and second cylindrical winding members and has a cross-sectional width which becomes narrower with reaching a rotational axis of each of said first and second cylindrical winding members.

3. The optical fiber holder according to claim 2, wherein in each of said first and second cylindrical winding members, the groove has a bottom of planar shape.

4. The optical fiber holder according to claim 2, wherein in each of said first and second cylindrical winding members, the groove has a bottom of curved shape.

5. The optical fiber holder according to claim 1, wherein in each of said first and second cylindrical winding members, the groove is formed in a spiral fashion in a lateral surface of each of said first and second cylindrical winding members, and in either said first cylindrical winding member or said second cylindrical winding member, the spiral groove has 3 or more turns.

6. The optical fiber holder according to claim 1, wherein the groove of said first cylindrical winding member is so formed as to rotate in a spiral fashion in a direction different from that in which the groove of said second cylindrical winding member rotates when viewed in a direction of rotational axes of said first and second cylindrical winding members, and wherein said first and second cylindrical winding members are arranged so that an offset between them with respect to the direction of the rotational axes of said first and second cylindrical winding members is substantially set to zero.

7. The optical fiber holder according to claim 1, wherein the groove of said first cylindrical winding member is so formed as to rotate in a spiral fashion in a same direction as that in which the groove of said second cylindrical winding member rotates when viewed in a direction of rotational axes of said first and second cylindrical winding members, and wherein said first and second cylindrical winding members are arranged so that an offset between them with respect to the direction of the rotational axes of said first and second cylindrical winding members is substantially equal to a width of an area of each of said first and second cylindrical winding members, on which said optical fiber can be wound.

8. The optical fiber holder according to claim 1, further comprising a sleeve having a crack and formed like a straw, for enclosing said optical fiber.

9. The optical fiber holder according to claim 1, further comprising a base secured to said first cylindrical winding member, a stage for holding said second cylindrical winding member and for moving said second cylindrical winding member in a direction of a length of said optical fiber, and an adjustment means for moving said stage so as to adjust a distance between said base and said stage.

10. The optical fiber holder according to claim 9, further comprising a sensor placed between said base and said adjustment means, for detecting a distortion or tension which is applied thereto by said base and said adjustment means when the distance between said base and said stage is adjusted by said adjustment means.

11. The optical fiber holder according to claim 10, further comprising a control means for controlling the distortion or tension which is applied to said sensor by said base and said adjustment means by referring to the distortion or tension detected by said sensor.

12. The optical fiber holder according to claim 9, wherein each of said first and second cylindrical winding members is held rotatably so that it can rotate around its rotational axis and is provided with a rotation lock mechanism for locking the rotation of each of said first and second cylindrical winding members around the rotational axis.

13. An optical fiber grating forming apparatus comprising:
at least an optical fiber holder including a first cylindrical winding member having a groove along which an end portion of an optical fiber is wound thereon, a second cylindrical winding member having a groove along which another end portion of said optical fiber is wound thereon and placed at a predetermined distance from said first cylindrical winding member, and a moving means for moving at least one of said first and second cylindrical winding members so as to apply a tension to said optical fiber;
a laser light source for emitting ultraviolet laser light;
a scanning means for scanning the ultraviolet laser light from said laser light source in a direction of a length of at least said optical fiber, which is being held by said optical fiber holder substantially in parallel with one or more other optical fibers; and
a phase mask for projecting the ultraviolet laser light from said scanning means onto at least said optical fiber as an interference pattern.

14. An optical fiber grating forming method comprising the steps of:
removing a part of a sheath of an optical fiber cut to an appropriate length so that an optical fiber grating can be formed in said optical fiber;
applying a tension to said optical fiber by using an optical fiber holder including a first cylindrical winding member having a groove along which an end portion of said optical fiber is wound thereon, a second cylindrical winding member having a groove along which another end portion of said optical fiber is wound thereon and placed at a predetermined distance from said first cylindrical winding member, and a moving means for moving at least one of said first and second cylindrical winding members so as to apply the tension to said optical fiber;
scanning ultraviolet laser light from a laser light source in a direction of a length of said optical fiber which is being held by said optical fiber holder; and
projecting the scanned ultraviolet laser light, by way of a phase mask and the removed part of the sheath of said optical fiber, onto said optical fiber as an interference pattern.
